(19) United States
(12) Patent Application Publication
(10) Pub. No.: US 2011/0010153 A1
(43) Pub. Date: Jan. 13, 2011

(54) MODEL ANALYSIS SYSTEM, MODEL ANALYSIS METHOD, AND MODEL ANALYSIS PROGRAM

(75) Inventor: Ichiro Hirata, Tokyo (JP)

Correspondence Address: Mr. Jackson Chen, 6535 N. STATE HWY 161, IRVING, TX, 75039, US

(73) Assignee: NEC CORPORATION, Tokyo (JP)

(21) Appl. No.: 12/919,457

(22) PCT Filed: Dec. 10, 2008
(86) PCT No.: PCT/JP2008/072388

§ 371 Date: Aug. 25, 2010

(30) Foreign Application Priority Data
Feb. 29, 2008 (JP) 2008-050680

(51) Int. Cl. G06G 7/48

(52) U.S. Cl. 703/9

(57) ABSTRACT

To improve the precision of an analysis of a finite element model. A model analysis system analyzes a state change according to a temperature and/or an external force in a finite element model of an object including a fluid portion and a structure portion coupled together. Further, the model analysis system includes pressure information calculation means that calculates pressure information of the fluid portion based on a surface tension of the fluid portion, model generation means that performs an element division for the fluid portion and the structure portion as a structure, and generates the finite element model, and model analysis means that analyzes the state change of the finite element model generated by the model generation means based on the pressure information of the fluid portion calculated by the pressure information calculation means.

### TECHNICAL FIELD

The present invention relates to a model analysis system, a model analysis method, and a model analysis program that analyze a finite element model, and more specifically to a model analysis system, a model analysis method and a model analysis program that analyze a state change according to a temperature or an external force in a finite element of an object including a fluid portion and a structure portion coupled together.

### BACKGROUND ART

Recently, electronic parts and a printed wiring substrate having the electric parts mounted thereon are gradually becoming thinner. As a result, the flexural rigidity thereof tends to decrease. Therefore, in a soldering process such as a reflowing process or the like, when the electronic parts and printed wiring substrate are heated, these electronic parts and printed wiring substrate are bent to a large extent. Therefore, unmelting of a solder can occur. The occurrence of the unmelting of the solder causes a connection reliability after solidification of a solder to be greatly deteriorated. To solve the problem, a technology has been developed in which a warpage behavior in a reflowing process is grasped in advance, and in an upstream stage of design, the countermeasure for reducing the warpage is taken. Further, as it is difficult to monitor the warpage behavior of the electronic parts and printed wiring substrate under a high temperature by an experimentation, various technologies for predicting the warpage have been studied. For example, a structure analysis (simulation) is performed by using a finite element method (FEM).

Incidentally, in the reflowing process, the electronic parts and the printed wiring substrate act as a structure, and the solder acts as a fluid since the solder melts. Therefore, it is impossible to analyze the melting solder as a fluid in a structure solver of a current general-purpose structure analysis software, and thus an elasticity analysis is principally performed in which only material characteristics after the solidification of the solder are considered. Further, in resin filling or the like to reinforce a soldered portion in an LSI molding process or an LSI packaging process, there is an increasing demand for a highly precise analysis is raised in case a fluid portion and a structure portion coexist. To solve the problem, a coupling analysis between the fluid portion and the structure portion is required.

As a coupling analysis method between the fluid portion and the structure portion, a coupling numerical value simulation is known in which an analysis function of a fluid software is merely incorporated in a structure analysis software (for example, refer to Patent Document 1). Further, a fluid structure coupling analysis method is known in which the analysis result of a fluid analysis software and the analysis result of a structure analysis software are exchanged through an interface (for example, refer to Patent Document 2).

### [Patent Document 1]

### Japanese Unexamined Patent Application Publication No. 2007-122269

### [Patent Document 2]

### Japanese Unexamined Patent Application Publication No. 2006-72566

### DISCLOSURE OF INVENTION

### Technical Problem

In the coupling numerical value simulation shown in Patent Document 1, as above mentioned, a part of the analysis function of the fluid software is merely incorporated in the structure analysis software. Therefore, a whole model is constructed as a structure, the fluid analysis is performed in the fluid portion by using the fluid software, and the whole body is balanced. However, the fluid portion in which the fluid analysis is performed has a limitation in which only an orthogonal mesh is applicable. Therefore, the other structure model is also restricted by the limitation, which can make it difficult to model a curvature portion. Accordingly, an analysis precision of the finite element model can be deteriorated.

Furthermore, when the whole model is used as a structure, the structure can be reflected by only a pressure, and the fluid portion and the structure portion are respectively and independently balanced. Therefore, it becomes difficult to apply an external force (a load, pressure, or the like) to the whole model including the fluid portion, and the analysis precision of the finite element method can decline.

On the other hand, in the fluid structure coupling analysis method shown in Patent Document 2, as above mentioned, the analysis result of the fluid analysis software and the analysis result of the structure analysis software are exchanged though the interface. Therefore, in the same way as Patent Document 1, it is restricted by the limitation in which the only orthogonal mesh is applicable, which can make it difficult to model the curvature portion. Further, it can become difficult to apply an external force to the whole model including the fluid portion. Furthermore, the model generated in Patent Document 2 is a weak coupling in which the fluid portion and the structure portion are separated. Therefore, the analysis precision of the finite element method can decline more, compared with the model which is constituted as a strong coupling and is generated in Patent Document 1.

The present invention has been made to solve the above-mentioned problems and an principal object of the invention is to provide a model analysis system, a model analysis method, and a model analysis program in which the analysis precision of a finite element model is improved.

### Technical Solution

To achieve the above-described object, an exemplary aspect of the present invention is a model analysis system that analyzes a state change according to a temperature and/or an external force in a finite element model of an object including a fluid portion and a structure portion coupled together, including: pressure information calculation means that calculates a pressure information of the fluid portion based on a surface tension of the fluid portion; model generation means that performs an element division for the fluid portion and the structure portion as a structure, and generates the finite element model; and model analysis means that analyzes the state change of the finite element model generated by the model generation means, based on the pressure information of the fluid portion calculated by the pressure information calculation means.

On the other hand, to achieve the above-described object, an exemplary aspect of the present invention may be a model analysis method that analyzes a state change according to temperature and/or external force in a finite element model of an object including a fluid portion and a structure portion coupled together, including: a pressure information calculation step of calculating a pressure information of the fluid portion based on a surface tension of the fluid portion; a model generation step of performing an element division for the fluid portion and the structure portion as a structure, and generating the finite element model; and a model analysis step of analyzing the state change of the finite element model generated in the model generation step based on the pressure information of the fluid portion calculated in the pressure information calculation step.

Note that to achieve the above-described object, an exemplary aspect of the present invention may be a model analysis program that analyzes a state change according to a temperature and/or an external force in a finite element model of an object including a fluid portion and a structure portion coupled together, executing: a pressure information calculation function that calculates a pressure information of the fluid portion based on a surface tension of the fluid portion; a model generation function that performs an element division for the fluid portion and the structure portion as a structure, and generates the finite element model; and a model analysis function that analyzes the state change of the finite element model generated by the model generation function based on the pressure information of the fluid portion calculated by the pressure information calculation function.

### Advantageous Effects

According to the present invention, it is possible to improve an analysis precision of a finite element model.

### BRIEF DESCRIPTION OF DRAWINGS

FIG. 1 is a schematic block diagram showing a configuration of a model analysis system according to an exemplary embodiment of the present invention;

FIG. 2 is a diagram showing an exemplary embodiment of a mounting state of a solder ball serving as a fluid portion, and an electronic part and a printed wiring substrate serving as a structure portion;

FIG. 3 is a flowchart showing an example of a processing flow according to an exemplary embodiment of the present invention; and

FIG. 4 is a diagram showing an example constituting of a program in which a surface extraction portion and a pressure information calculation portion are constituted by a program that is read into a data processing device.

### EXPLANATION OF REFERENCE

1 INPUT DEVICE
2 DATA PROCESSING DEVICE
2a ANALYSIS DATA ACQUISITION PORTION (ANAYSIS DATA ACQUISITION MEANS)
2b MODEL GENERATION PORTION (MODEL GENERATION MEANS)
2c SURFACE EXTRACTION PORTION (SURFACE EXTRACTION MEANS)
2d EXTERNAL FORCE APPLYING PORTION (EXTERNAL FORCE APPLYING MEANS)
2e TEMPERATURE APPLYING PORTION (TEMPERATURE APPLYING MEANS)
2f PRESSURE INFORMATION CALCULATION PORTION (PRESSURE INFORMATION CALCULATION MEANS)
2g MODEL ANALYSIS PORTION (MODEL ANALYSIS MEANS)
3 STORAGE DEVICE
4 OUTPUT DEVICE

### BEST MODE FOR CARRYING OUT THE INVENTION

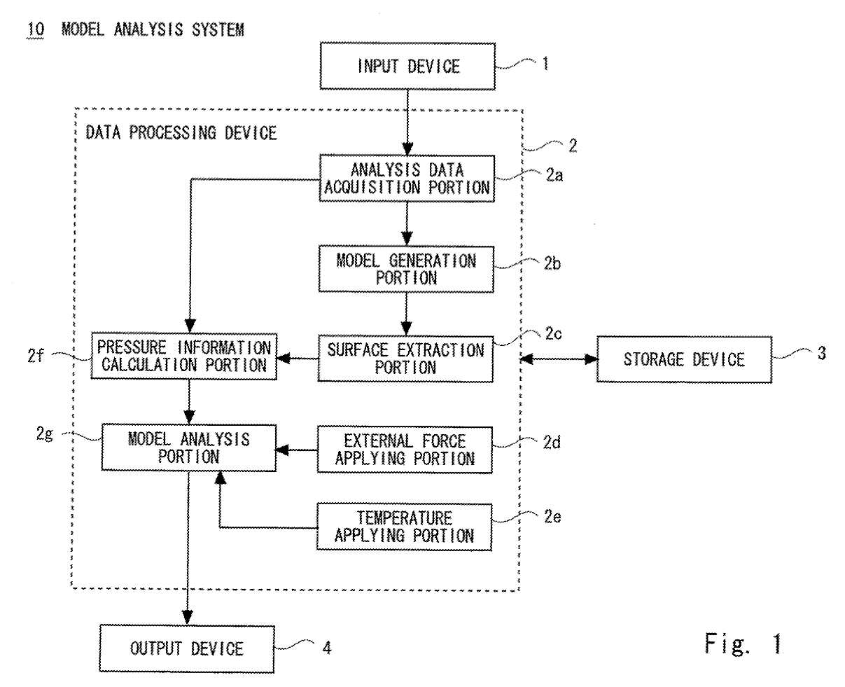

An exemplary embodiment of a best mode for carrying out the present invention is explained hereinafter with reference to the accompanying drawings. FIG. 1 is a schematic block diagram showing a configuration of a model analysis system according to an exemplary embodiment of the present invention.

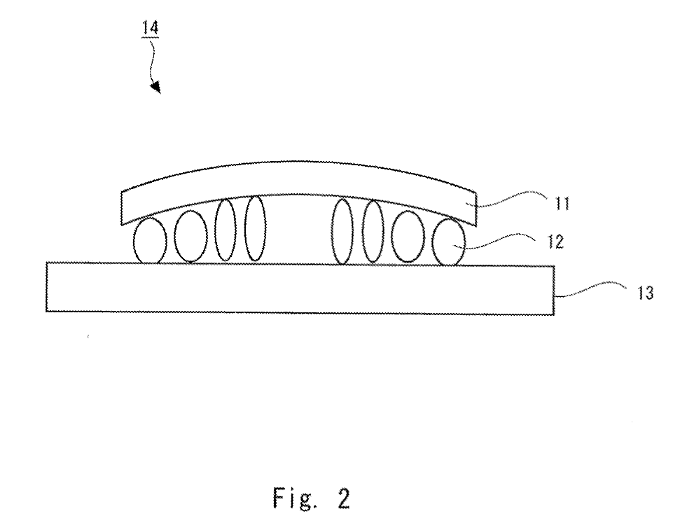

A model analysis system 10 according to the present embodiment can analyze, with high precision, a state change according to a temperature and/or an external force in a finite element model of an object including a fluid portion and a structure portion coupled together. Herein, for example, an electronic circuit device 14 in which an electronic part 11 (a surface implementation part) such as BGA, CPS, or the like is mounted on a printed wiring substrate 13 via a melting solder ball 12, is used as the aforementioned object (FIG. 2). Further, the electronic part 11 and/or the printed wiring substrate 13 corresponds to the aforementioned structure portion, and the melting solder ball 12 corresponds to the aforementioned fluid portion, respectively.

In a reflowing treatment process in which the electronic part 11 is soldered on the printed wiring substrate 13, the state change occurs according to the aforementioned temperature and/or external force due to the warping, stress, or the like of the electronic part 11 or the printed wiring substrate 13 generated by a load of the electronic part 11, a heat generated in soldering and a curvature portion of the solder ball 12. The model analysis system 10 according to the present embodiment can analyze, with high precision, the state change, which occurs over the entire object 14 including the fluid portion 12 and the structure portion 11, 13 coupled together. For example, analyzing, with high precision, the connection between the melting solder ball 12 which is a fluid and the electronic part 11 as well as the printed wiring substrate 13, can prevent the unmelting of the solder in a design stage. Furthermore, after the solder is solidified, soldering conditions can also be optimized to prevent the connection reliability of the solder from deteriorating.

The model analysis system 10 according to the present embodiment includes, as principal hardware configurations, an input device 1 which inputs analysis data, a data processing device 2 which performs an analysis process of the analysis data, a storage device 3 which stores various data, and an output device 4 which outputs an analysis result or the like (FIG. 1).

As the input device 1, an optional device such as, for example, a keyboard, a mouse, a touch panel device, a voice input device, the which a user can input data, can be used. Further, various analysis data such as shape data of the electronic part 11 and the printed wiring substrate 13 (e.g. dimensions (a thickness or the like), Young's modulus, Poisson's ratio, an elastic material characteristic value such as a coefficient of linear expansion or the like), a weight of the electronic part 11, a surface tension γ of the melting solder ball 12, an after-mentioned temperature applying curve, an after-mentioned external force applying curve, or the like, are input into the input device 1. The input device 1 is connected to the data processing device 2.

The data processing device 2 performs a data analysis of the finite element model, based on the aforementioned analysis data input by the input device 1. Note that it may be configured such that the aforementioned analysis data is stored in the storage device 3 in advance, and the data processing device 2 properly can read the analysis data of a data library stored in the storage device 3.

The data processing device 2 includes, as principal hardware configurations, a CPU (Central Processing Unit) which performs a calculation process or the like, a ROM (Read Only Memory) in which a calculation program or the like to be executed by the CPU is stored, and a RAM (Random Access Memory) which temporally stores the analysis data or the like. Further, the CPU, ROM and RAM are connected to each other via a data bus.

The data processing device 2 includes an analysis data acquisition portion 2a which acquires the analysis data, a model generation portion 2b which generates the finite element model of the object, a surface extraction portion 2c which extracts a surface portion of a fluid, an external force applying portion 2d which applies the external force to the finite element model, a temperature applying portion 2e which applies the temperature to the finite element model, a pressure information calculation portion 2f which calculates pressure information, and a model analysis portion 2g which analyzes the state change of the finite element model.

The analysis data acquisition portion 2a puts, for example, shape data of the electronic part 11 and the printed wiring substrate 13 (e.g. dimensions (a thickness or the like), Young's modulus, Poisson's ratio, an elastic material characteristic value such as a coefficient of linear expansion or the like), a weight of the electronic part 11, a surface tension γ of the melting solder ball 12 which is the fluid portion 12, the after-mentioned temperature applying curve, the after-mentioned external force applying curve, or the like, among the necessary analysis data to perform the aforementioned analysis of the finite element model, into the data processing device 2. Note that the analysis data acquisition portion 2a can also properly put the aforementioned analysis data stored in the storage device 3 in advance into the data processing device 2. Further, the analysis data acquisition portion 2a is connected to the model generation portion 2b and the pressure information calculation portion 2f.

The model generation portion 2b generates the finite element model of the object 14 which includes the fluid portion 12 and the structure portions 11, 13 based on the finite element method (FEM), by using the analysis data acquired by the analysis data acquisition portion 2a.

The model generation portion 2b performs an element division (meshing), for not only the electronic part 11 and the printed wiring substrate 13 which are the structure portions 11, 13 but also for the solder ball 12 which is the fluid 12 as a structure. Namely, the model generation portion 2b performs the element division for the finite element model of the whole of the object 14 which includes the curvature portion of the solder ball 12 corresponding to the fluid portion 12, by using a structure mesh (a structure software) which is not restricted by the limitation in which only orthogonal element division is applicable, and can deal with the curvature portion. In this manner, it is not restricted by the orthogonal element division, and it is possible to precisely perform the element division for the curvature portion. Therefore, it becomes possible to perform the high precise coupling analysis of the finite element model.

Further, the model generation portion 2b sets the material characteristic value of each of the electronic part 11, the solder ball 12, and the printed wiring substrate 13 acquired from the analysis data acquisition portion 2a, respectively, to the finite element model. Furthermore, the model generation portion 2b sets restriction conditions and load conditions to the finite element model, and completes the finite element model. The model generation portion 2b is connected to the surface extraction portion 2c.

The surface extraction portion 2c extracts the surface portion which does not contact another component, from the surface portion of the fluid portion 12 in the finite element model generated by the model generation portion 2b (namely, the surface portion on which the surface tension γ acts). For example, the surface extraction portion 2c analyzes a relation among each element of the finite element model in which the element division is performed, and extracts an element group including an element face or a panel point which is not connected another element, as the aforementioned surface portion of the fluid portion 12. The surface extraction portion 2c is connected to the pressure information calculation portion 2f and the model analysis portion 2g.

The external force applying portion 2d applies the external force such as a load or the like to an optional portion in the finite element model generated by the model generation portion 2b, according to the external force applying curve acquired by the analysis data acquisition portion 2a. The external force applying portion 2d can apply, for example, a load which is equivalent to the weight of the electronic part 11 and which is acquired by the analysis data acquisition portion 2a, to a required portion of the finite element model. The external force applying portion 2d is connected to the model analysis portion 2g.

The temperature applying portion 2e applies a temperature to an optional portion in the finite element model generated by the model generation portion 2b, according to the temperature applying curve acquired by the analysis data acquisition portion 2a. The external force is applied to the finite element model by the external force applying portion, 2d, and the temperature is applied to the finite element model by the temperature applying portion 2e. Accordingly, for example, the model analysis portion 2g can analyze, with high precision, various phenomena which occur in the reflowing process, such that the weight of the electronic part 11 is applied and the thermal deformation of the electronic part 11 and the printed wiring substrate 13 causes the warping. The temperature applying portion 2e is connected to the model analysis portion 2g.

The pressure information calculation portion 2f calculates an interior and exterior pressure difference ΔP in the surface portion of the fluid portion 12, based on principal radius of curvature R1, R2 of the surface portion of the fluid portion 12 extracted by the surface extraction portion 2c, and the surface tension y of the fluid portion 12 acquired by the analysis data acquisition portion 2a, by using the after-mentioned expression (1) (Laplace expression).

ΔP=γ(1/R1+1/R2) expression (1)

For example, in case the solder ball 12 corresponding to the fluid portion 12 is an eutectic solder (Sn-37Pb), the surface tension γ is approximately 3.9×10⁻⁵ (kgf/mm). Further, assuming that the principal radius of curvature R1 of the panel point corresponding to the aforementioned interior and exterior pressure difference ΔP to be calculated in the finite element model, is approximately 0.2 (mm). Note that when a two-dimensional finite element analysis is performed, the term of R2 in the aforementioned expression (1) can be excluded. In this case, when the interior and exterior pressure difference ΔP is calculated by using the aforementioned expression (1), ΔP=1.56×10⁴ (kgf/mm²) is obtained. As above mentioned, by using the aforementioned expression (1), it is possible to convert the surface tension γ of each panel point in the finite element model into the interior and exterior pressure difference ΔP which is equivalent to the surface tension γ.

Thus, the surface tension γ of the fluid portion 12 is converted into the interior and exterior pressure difference ΔP which is applicable for the structure analysis software, and as after-mentioned, the interior and exterior pressure difference ΔP is applied to the surface portion of the fluid portion 12. Accordingly, the model generation portion 2b can perform the element division for the finite element model of the whole of the object 14 which includes the curvature portion of the fluid portion 12 with high precision, by using the structure analysis software, but without using the fluid analysis software in which only an orthogonal element division is applicable. Furthermore, as aforementioned, an optional external force is applied by the external force applying portion 2d, and in its effect, it is possible to perform the structure analysis for the warping, stress, or the like in the finite element model of the whole of the object 14 including the fluid portion 12, by using only the structure analysis software. Therefore, it becomes possible to perform the high precise coupling analysis.

The model analysis portion 2g applies the interior and exterior pressure difference ΔP of the surface portion of the fluid portion 12 calculated by the pressure information calculation portion 2f, to the surface portion of fluid portion 12 extracted by the surface extraction portion 2c, in the normal direction of the surface portion, and analyzes, with high precision, the state change of the finite element model (for example, a deformation such as warping or the like, a stress).

Further, model analysis portion 2g analyzes the state change of the finite element model, when the external force is applied to the finite element model by the external force applying portion 2d, and/or when the temperature is applied to the finite element model by the temperature applying portion 2e. Accordingly, it is possible to analyze, with high precision, the state change of the finite element model according to the optional temperature and external force. The data processing device 2 is connected to each of the storage device 3 and the output device 4.

The storage device 3 properly stores the analysis data analyzed by the model analysis portion 2g of the data processing device 2. As the storage device 3, for example, a magnetic disk storage device, an optical disk storage device, or the like, can be used.

The output device 4 outputs the analysis data analyzed by the model analysis portion 2g of the data processing device 2 to a user. As the output device 4, for example, a display device, a printer device, or the like can be used.

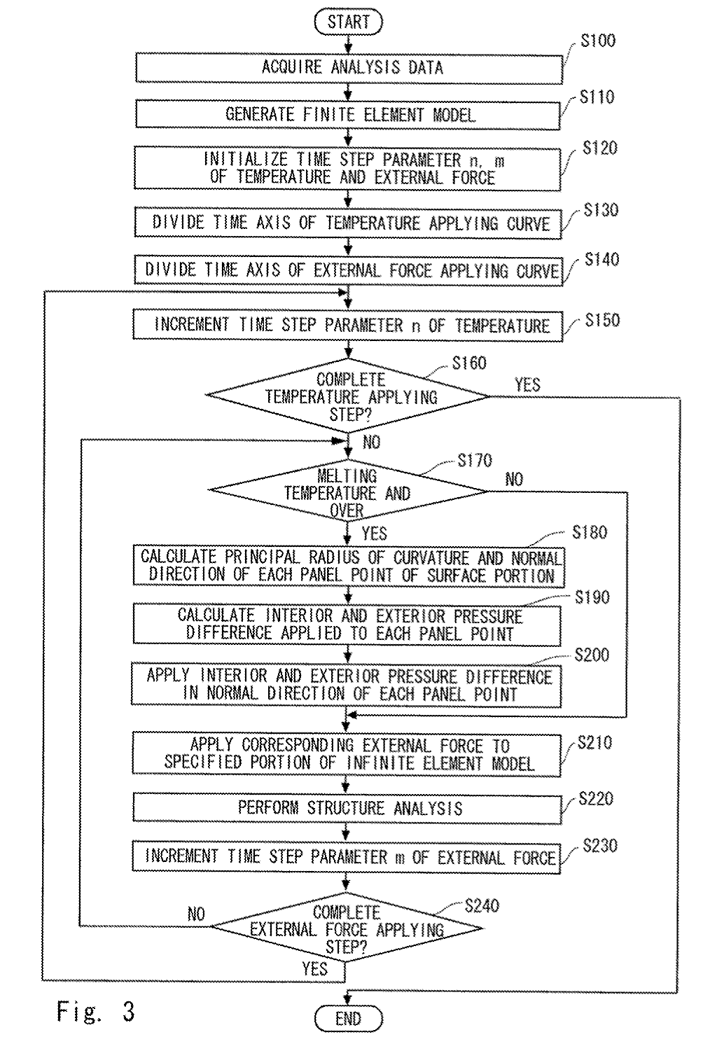

Next, an example of a processing flow of the model analysis system 10 according to the present embodiment would be explained in detail. FIG. 3 is a flowchart showing an example of the processing flow of the model analysis system according to the present embodiment.

The analysis data acquisition portion 2a of the data processing device 2 acquires the necessary analysis data to analyze the finite element model which is input into the input device 1 by the user (analysis data acquisition step) (S100).

The model generation portion 2b generates the finite element model of the electronic circuit device 14, which includes the solder ball 12 corresponding to the fluid portion 12 and the electronic part 11 and the printed wiring substrate 13 respectively corresponding to the structure portions 11, 13, by using the analysis data acquired by the analysis data acquisition portion 2a (model generation step) (S110).

The temperature applying portion 2e of the data processing device 2 initializes a time step parameter n of the temperature applying curve (n=0), and the external force applying portion 2d initializes a time step parameter m of the external force applying curve (m=0) (S120).

Next, the temperature applying portion 2e uniformly divides a time axis T1 of the temperature applying curve by a predetermined gap Δt1 (S130), and calculates an after-mentioned predetermined value N (N=T1/Δt1). Further, the external force applying portion 2d uniformly divides a time axis T2 of the external force applying curve by a predetermined gap Δt2 (S140), and calculates an after-mentioned predetermined value M (M=T2/Δt2).

Note that the time axis T1 is uniformly divided by the predetermined gap Δt1, however, the suddenly changing portion in the temperature applying curve may be finely divided. In the same manner, the time axis T2 is uniformly divided by the predetermined gap Δt2, however, the suddenly changing portion in the external force applying curve may be finely divided. Accordingly, it is possible to analyze, with high precision, the state change of the finite element model which changes in a time series, based on the temperature applying curve or the external force applying curve.

Subsequently, the temperature applying portion 2e increments the time step parameter n (n=n+1), and applies the temperature corresponding to the time step parameter n, to the finite element model, based on the temperature applying curve (temperature applying step) (S150). Accordingly, it is possible to analyze, with high precision, the state change of the finite element model which changes in a time series, based on the temperature applying curve. Note that 1 is added to the aforementioned time step parameter n (n=n+1), however, the added number can be optionally set (for example, n=n+2).

The temperature applying portion 2e decides whether the time step parameter n is equal to or greater than the predetermined value N (n≧N), and the temperature applying step has been completed or not (S160).

When the temperature applying portion 2e decides that the temperature applying step has not been completed (No in S160), the temperature applying portion 2e decides whether the applied temperature is equal to or higher than a melting temperature (melting point) of the solder or not (S170). On the other hand, when the temperature applying portion 2e decides that the temperature applying step has been completed (YES in S160), the processing is completed.

When the temperature applying portion 2e decides that the applying temperature is equal to or higher than the melting temperature of the solder, and that the solder ball becomes a fluid (YES in S170), the surface extraction portion 2c extracts the surface portion of the solder ball 12 (surface extraction step). Then, the pressure information calculation portion 2f calculates the principal radius of curvature R1, R2 of each panel point and the normal direction of each panel point in the surface portion of the solder ball 12 extracted by the surface extraction portion 2c (S180).

Further, the pressure information calculation portion 2f calculates the interior and exterior pressure difference ΔP of each panel point of the surface portion, based on the calculated principal radius of curvature R1, R2 of each panel point in the surface portion and the surface tension γ of the solder ball 12 acquired by the analysis data acquisition portion 2a, by using the aforementioned expression (1) (pressure information calculation step) (S190).

The model analysis portion 2g applies the interior and exterior pressure difference ΔP corresponding to each panel point of the surface portion calculated by the pressure information calculation portion 2f, to each panel point of the surface portion extracted by the surface extraction portion 2c, in the normal direction of each panel point of the surface portion (S200). Accordingly, the model analysis portion 2g can apply the interior and exterior pressure difference ΔP which is equivalent to the surface tension γ, to the surface portion of the fluid portion 12.

On the other hand, when the temperature applying portion 2e decides that the applied temperature is lower than the melting temperature of the solder, and the solder ball 12 does not become a fluid (it is solidified) (NO in S170), the process is proceeded to the next process (S210). In this case, the solder ball 12 becomes solid, and the surface tension γ cannot act. Therefore, the processes of the aforementioned (S180) to (S200) are omissible. Further, the model generation portion 2b sets the material characteristic value of the solidified solder ball 12 acquired by the analysis data acquisition portion 2a, and generates the finite element model.

The external force applying portion 2d applies the external force corresponding to the time step parameter m, to the specified portion of the finite element model generated by the model generation portion 2b, based on the external force applying curve (S210). Accordingly, it is possible to analyze, with high precision, the state change of the finite element model which changes in a time series based on the external force applying curve.

The model analysis portion 2g analyzes the structure of the finite element model to which the temperature is applied by the temperature applying portion 2e and the external force is applied by the external force applying portion 2d, by using the structure analysis software (model analysis step) (S220). The model analysis portion 2g sends the analysis result to the storage device 3 and the output device 4. The storage device 3 stores the analysis result received from the model analysis portion 2g, and the output device 4 displays and outputs the analysis result received from the model analysis portion 2g to the user.

The external force applying portion 2d increments the time step parameter m (m=m+1) (S230). Then, the external force applying portion 2d decides whether the time step parameter m is equal to or greater than the predetermined value M (m≧M), and the external force applying step has been completed or not (S240). Note that 1 is added to the aforementioned time step parameter m (m=m+1), however the added number can be optionally set (for example, m=m+3).

When the external force applying portion 2d decides the external force applying step has been completed (YES in S240), the process returns to the aforementioned process (S150). On the other hand, when the external force applying portion 2d decides that the external force applying step has not been completed (NO in S240), the process returns to the aforementioned process (S170).

As stated above, in the model analysis system 10 according to the present embodiment, the pressure information calculation portion 2f calculates the interior and exterior pressure difference ΔP of each panel point of the surface portion, based on the principal radius of curvature R1, R2 of each panel point in the surface portion of the fluid portion 12 and the surface tension γ of the fluid portion 12 acquired by the analysis data acquisition portion 2a. The model analysis portion 2g applies the interior and exterior pressure difference γP corresponding to each panel point of the surface portion calculated by the pressure information calculation portion 2f, to each panel point of the surface portion, in the normal direction of each panel point of the surface portion. Accordingly, it is possible to convert the surface tension γ, which acts on the fluid portion 12, into the interior and exterior pressure difference ΔP which is usable in the structure analysis software, and to apply the interior and exterior pressure difference ΔP to the finite element model. Therefore, it is possible to perform the element division for the finite element model of the whole of the object 14 which includes the curvature portion of the fluid portion 12, by using the structure analysis software which can deal with the curvature portion, but without using the fluid analysis software restricted by the orthogonal element division, and to perform the analysis of the finite element model. In other words, the precision of the analysis of the finite element model can be improved.

Further, as above stated, it is possible to perform the aforementioned element division and analysis by using only the structure analysis software, but without using the fluid analysis software. Therefore, all of the fluid portion and the structure portion can be treated as the structure. Accordingly, it is possible to analyze, with high precision, the state change of the whole finite element model, by applying the external force to the finite element model of the structure by the external force applying portion 2d. Note that since it is possible to perform the aforementioned element division and analysis by using only the structure analysis software, the system can be simplified and the cost can also be reduced.

Moreover, the temperature applying portion 2e applies the temperature corresponding to the time step parameter n, to the finite element model, and decides whether the applied temperature is equal to or higher than a melting temperature of the solder or not, based on the temperature applying curve. Therefore, it is possible to perform various process analyses according to the temperature change when the temperature is changed in the finite element model, and to result in the improvement of the utility of the system.

Note that the best mode for carrying out the present invention has been explained with reference to an exemplary embodiment, however, the present invention is not limited to the exemplary embodiment described above, and various modifications and substitutions can be made to the exemplary embodiment without departing from the scope of the present invention.

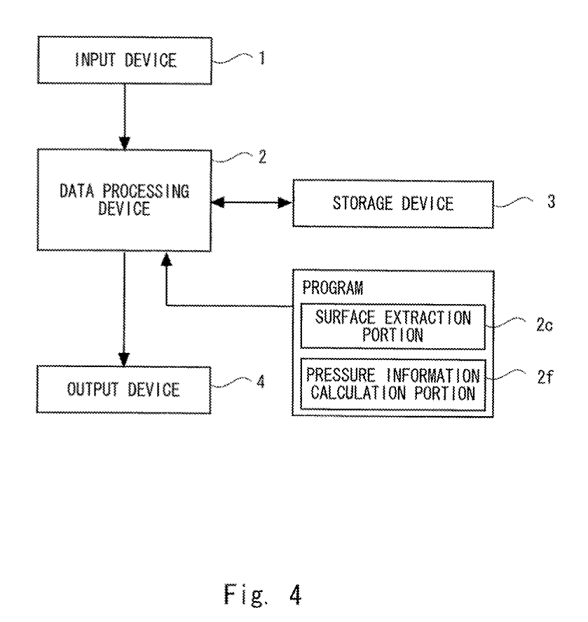

For example, in the aforementioned exemplary embodiment, the surface extraction portion 2c and the pressure information calculation portion 2f may consist of programs which are read into the data processing device 2 (FIG. 4). Further, an optional combination of the model generation portion 2b, the surface extraction portion 2c, the external force applying portion 2d, the pressure information calculation portion 2f, and the model analysis portion 2g may consist of the program, and it may configured that the program are read into the data processing device 2.

Further, in the aforementioned exemplary embodiment, the solder ball 12 is applied as the fluid portion 12, however, an optional solder which has a shape other than a ball shape can be applied. For example, it is also applicable that a QFP electronic component is connected through a lead frame with the solder.

This application is based upon and claims the benefit of priority from Japanese patent application No. 2008-050680, filed on Feb. 29, 2008, the disclosure of which is incorporated herein in its entirety by reference.

1. A model analysis system that analyzes a state change according to a temperature and/or an external force in a finite element model of an object including a fluid portion and a structure portion coupled together, comprising:
a pressure information calculation portion that calculates pressure information of the fluid portion based on a surface tension of the fluid portion;
a model generation portion that performs an element division for the fluid portion and the structure portion as a structure, and generates the finite element model; and
a model analysis portion that analyzes the state change of the finite element model generated by the model generation portion, based on the pressure information of the fluid portion calculated by the pressure information calculation portion.

2. The model analysis system according to claim 1, further comprising:
a analysis data acquisition portion that acquires analysis data of the object; and
a surface extraction portion that extracts a surface portion of the fluid portion of the finite element model generated by the model generation portion,
wherein the model generation portion generates the finite element model, based on the analysis data acquired by the analysis data acquisition portion, and
the model analysis portion applies the pressure information of the fluid portion calculated by the pressure information calculation portion, to the surface portion of the fluid portion extracted by the surface extraction portion, and analyzes the state change of the finite element model.

3. The model analysis system according to claim 2, wherein the pressure information calculation portion calculates an interior and exterior pressure difference in the surface portion of the fluid portion, based on a radius of curvature of the surface portion of the fluid portion extracted by the surface extraction portion and the surface tension of the fluid portion acquired by the analysis data acquisition portion.

4. The model analysis system according to claim 2, further comprising:
an external force applying portion that applies an external force to the finite element model generated by the model generation portion according to a predetermined external force applying curve; and
a temperature applying portion that applies a temperature to the finite element model generated by the model generation portion according to a predetermined temperature applying curve.

5. The model analysis system according to claim 3, wherein the fluid portion is a melting solder, the structure portion is a part to be soldered, and
when the temperature of the solder is equal to or higher than a melting temperature of the solder, by applying the temperature to the finite element model by the temperature applying portion, the model analysis portion applies the interior and exterior pressure difference of the fluid portion calculated by the pressure information calculation portion, to the surface portion of the fluid portion extracted by the surface extraction portion.

6. A model analysis method that analyzes a state change according to a temperature and/or an external force in a finite element model of an object including a fluid portion and a structure portion coupled together, comprising:
calculating pressure information of the fluid portion based on a surface tension of the fluid portion;
performing an element division for the fluid portion and the structure portion as a structure, and generating the finite element model; and
analyzing the generated state change of the finite element model based on the calculated pressure information of the fluid portion.

7. The model analysis method according to claim 6, further comprising:
aquiring analysis data of the object; and
extracting a surface portion of the fluid portion of the generated finite element model,
wherein the finite element model is generated based on the acquired analysis data, and
the calculated pressure information of the fluid portion is applied to the extracted surface portion of the fluid portion, and the state change of the finite element model is analyzed.

8. The model analysis method according to claim 7, further comprising:
applying an external force to the generated finite element model according to a predetermined external force applying curve; and
applying a temperature to the generated finite element model according to a predetermined temperature applying curve.

9. A computer readable medium storing a model analysis program that analyzes a state change according to a temperature and/or an external force in a finite element model of an object including a fluid portion and a structure portion coupled together, the model analysis program causing a computer to execute processing comprising:
calculating pressure information of the fluid portion based on a surface tension of the fluid portion;
performing an element division for the fluid portion and the structure portion as a structure, and the generated finite element model; and
analyzing the state change of the generated finite element model based on the calculated pressure information of the fluid portion.
